(19) United States
(12) Patent Application Publication
(10) Pub. No.: US 2008/0157041 A1
(43) Pub. Date: Jul. 3, 2008

(54) Collapsible engine hoist

(76) Inventor: Herb Martin, Avon, NY (US)

Correspondence Address: Dennis M. Connolly, 999 Lehigh Station Road, Henrietta, NY, 14467, US

(21) Appl. No.: 11/879,869

(22) Filed: Jul. 19, 2007

Related U.S. Application Data
(60) Provisional application No. 60/832,258, filed on Jul. 20, 2006.

(51) Int. Cl. B66F 7/26

(52) U.S. Cl. 254/2 R

(57) ABSTRACT

The present invention relates to a collapsible hoist that can be easily stored and set up. The hoist is designed to provide sufficient lifting support to lift large objects such as an engine out of an engine compartment. Further, the invention provides the ability to transport and operate a hoist in a garage or in the field

This application claims the benefit of U.S. Provisional Patent Application Ser. No. 60/832,258, filed Jul. 20, 2006, which is hereby incorporated by reference in its entirety.

### FIELD OF THE INVENTION

The present invention relates to a portable hoist which is designed to be collapsible and easily stored and set up.

### BACKGROUND OF THE INVENTION

Numerous devices have been developed for lifting of heavy loads. In particular, many various forms of engine hoists have been described or are commercially available. Known prior art engine hoists include U.S. Pat. No. 5,261,640; U.S. Pat. No. 5,052,566; U.S. Pat. No. 4,770,304; U.S. Pat. No. Des. 349,996; U.S. Pat. No. 4,497,469; U.S. Pat. No. 4,090,625, U.S. Pat. No. 5,897,101, and U.S. Pat. No. 5,261,640.

Many of the prior art devices are optimized for use in a garage environment and are not suitable for use in the field.

The current invention provides a lifting device capable of lifting large loads and being able to move the load once lifted. The device is collapsible so that it takes up minimal space and can be easily transported. Furthermore, the device is lightweight so that one or two men can set up and operate the hoist in the field. Furthermore, the device is designed to provide a high degree of stability and safety even when used to lift heavy objects such as large engines.

The current invention provides the ability to set up, taken down, and move quickly a stable hoist. This would be a plus especially in the trucking industry and a tremendous advantage to the military. In each case, a lifting device that can be quickly set up and used without the need of a power source such as hydraulics, electric motors, etc. just manpower, and if need be, by a single individual has great benefit.

In view of the foregoing background, it is therefore an object of the present invention to provide a portable engine hoist for automotive mechanics to lift and retrieve heavy engines from vehicles in remote locations, where traditional engine-hoisting devices cannot be operated.

### SUMMARY OF THE INVENTION

The current invention provides a collapsible hoist that can easily be set up in the field. The hoist is preferably used to lift engines and in particular engines from large trucks.

### BRIEF DESCRIPTION OF THE DRAWINGS

FIG. 1 shows a caster assembly.

FIG. 2 shows the hinge assembly.

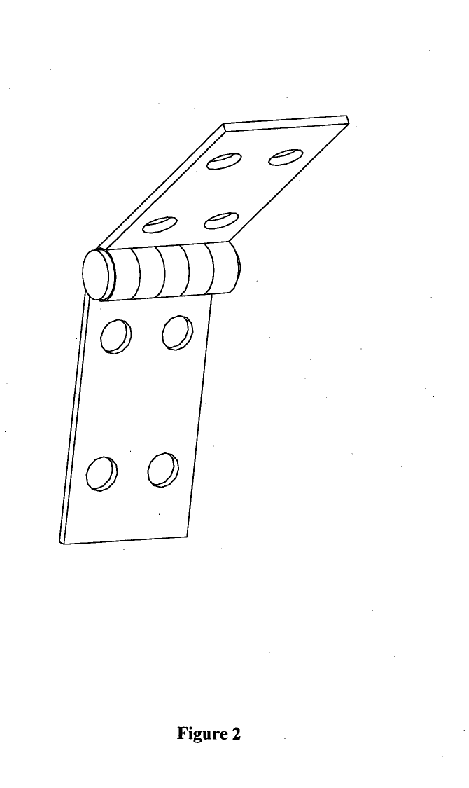

FIG. 3 shows the hinge sheath.

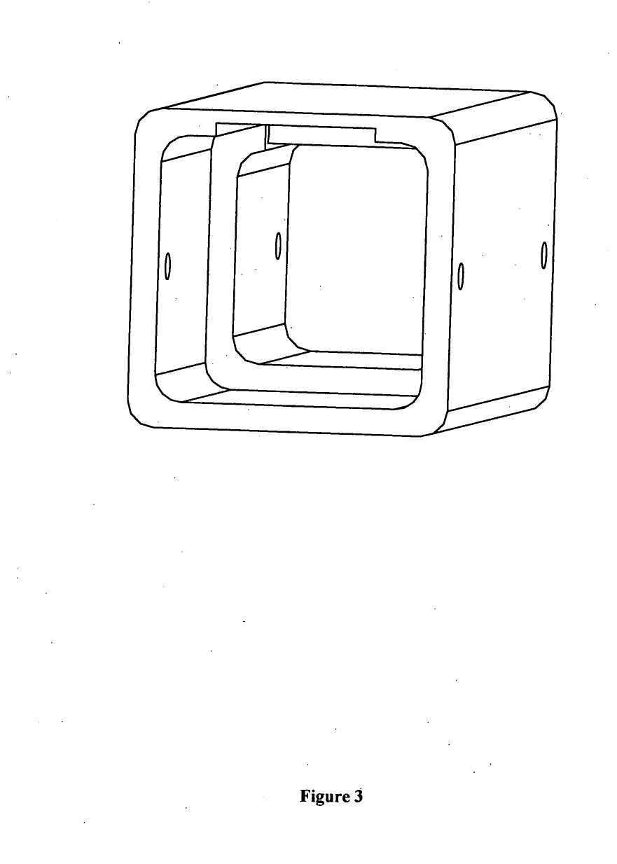

FIG. 4 shows the complete hoist assembly.

FIG. 5 shows the hoist assembly collapsed.

FIG. 6 shows the leg assembly.

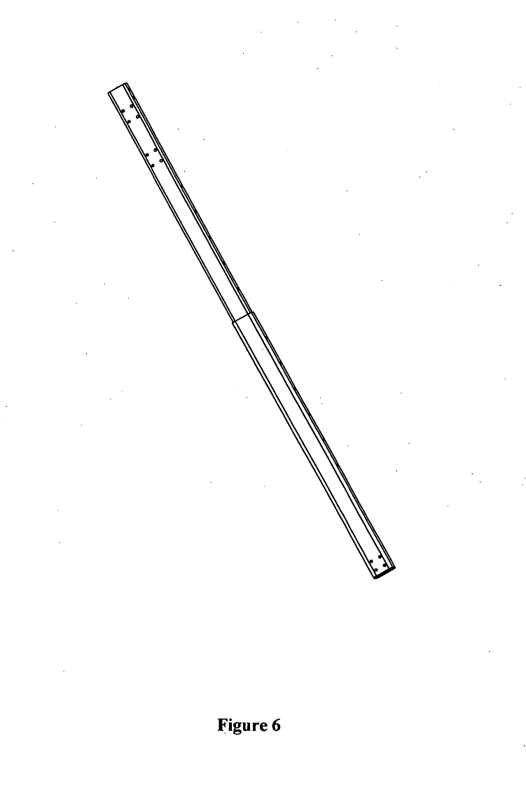

FIG. 7 shows the leg base assembly, including the castor.

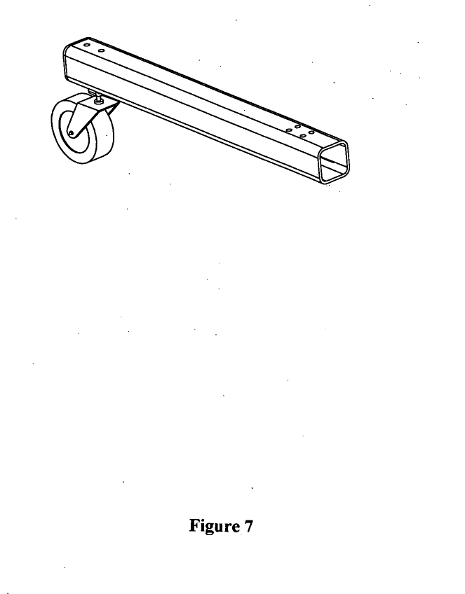

FIG. 8 shows the leg base assembly from below.

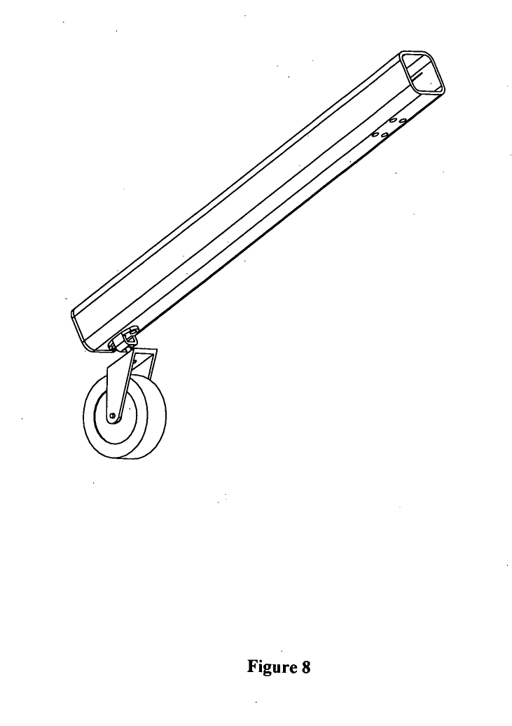

FIG. 9 shows the sheath grove.

FIG. 10 shows the sheath.

FIG. 11 shows the sheath tongue.

FIG. 12 shows the side lockside.

FIG. 13 shows the spring.

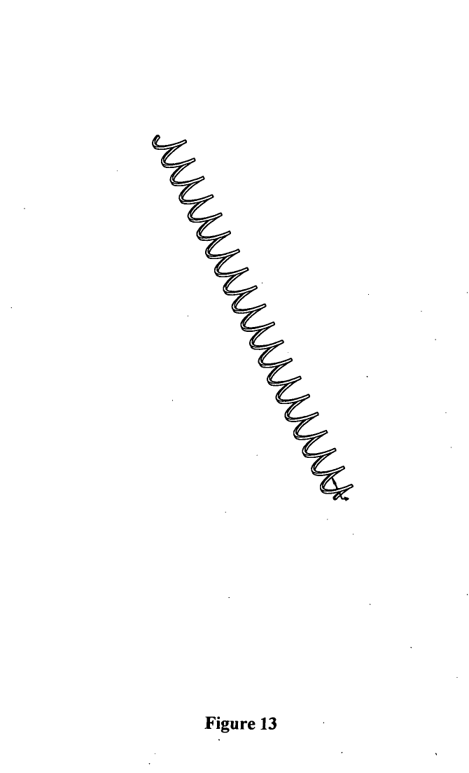

FIG. 14 shows the support arm.

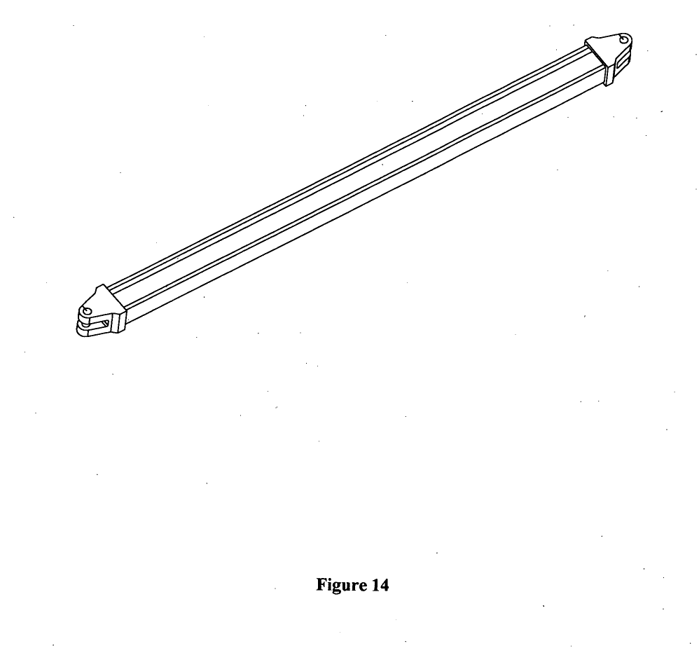

FIG. 15 shows the support beam assembly.

FIG. 16 shows the spring and support beam assembly.

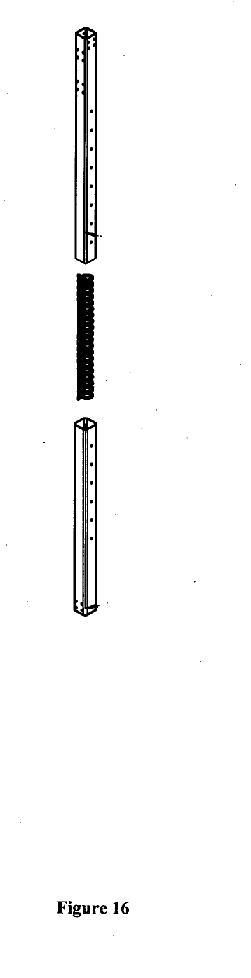

FIG. 17 shows the angle support.

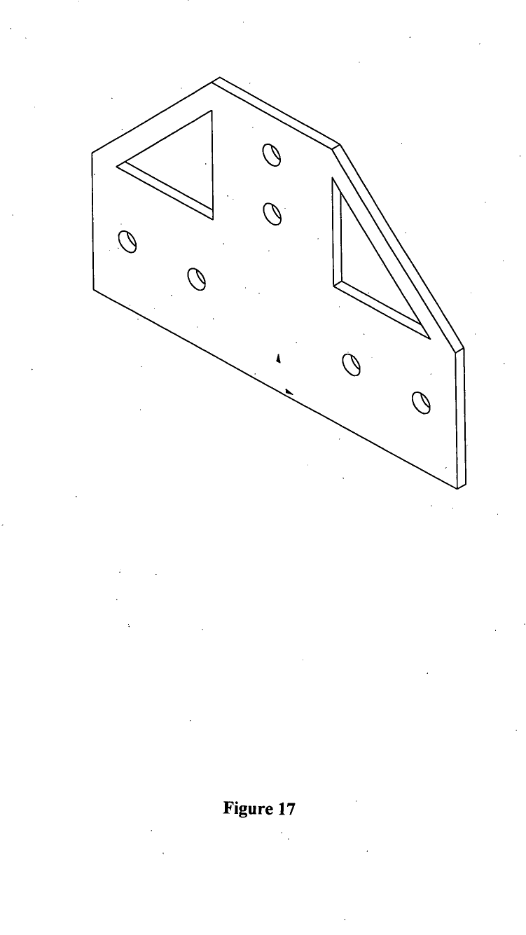

### DETAILED DESCRIPTION OF THE INVENTION

The current invention provides a device capable of lifting an engine out of an engine compartment. Further, the invention provides the ability to transport the engine. The device is collapsible requiring minimal storage space and is easily set up in a garage or in the field.

In a preferred embodiment of the invention, the hoist has sufficient with and height to provide sufficient clearance from trucks with larger clearance requirements.

In a preferred embodiment, the device is designed so that it extends at least eight feet high and has an eight foot width when fully extended. In a more preferred embodiment, the hoist has a height of ten feet and has a ten foot width when extended.

The device is easily assembled. Although bolts can be used to secure the components in position, the components are preferably secured in place with pins or sliding sleeves to minimize the amount of work necessary to assemble the device.

The weight of the device is minimized to increase the ease of assembly and use. Preferably, the device can be assembled by two individuals or more preferred be assembled by a single individual. The preferred weight is less than 500 pounds and more preferred if the total weight is less than 300 pounds. In another preferred embodiment, the device.

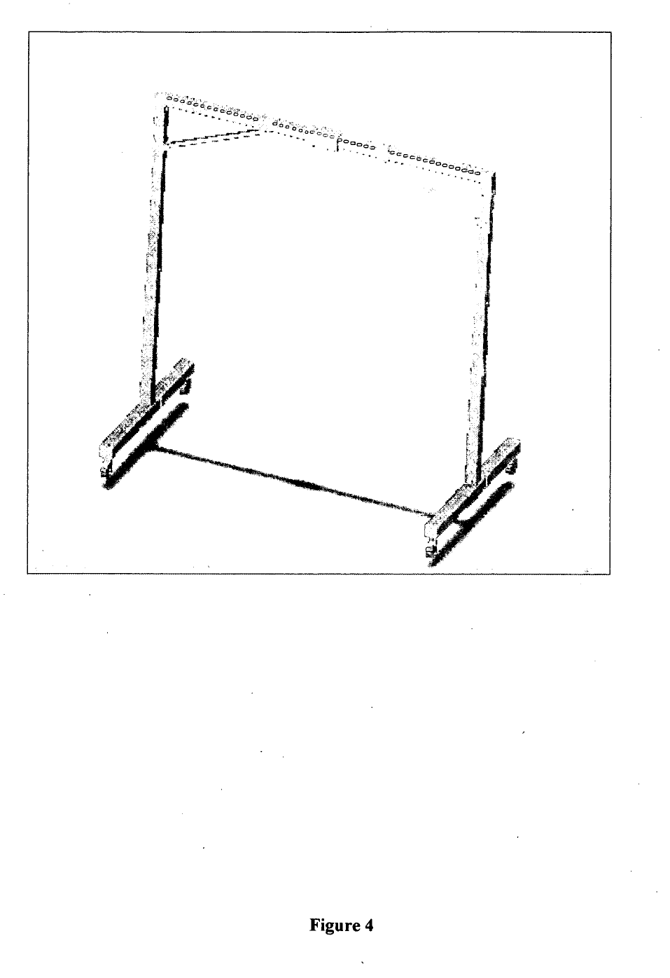

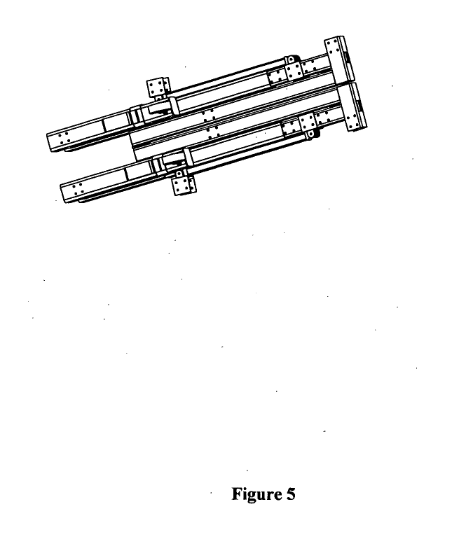

A preferred embodiment of the invention is depicted in FIG. 4 and FIG. 5. In FIG. 4, the hoist is set up for use. Two legs are supported by leg base assemblies. Each leg base assembly may be supported by rolling castors to allow for easy movement of the hoist. Angle supports are attached to the base of the leg assembly and are used to lock the leg assembly into place using pins or bolts. The leg assembly consists of two components, the first component slides inside the second component to allow the height to be varied and for collapse of the hoist when not in use. A spring may be used to assist in the extension of the leg assembly.

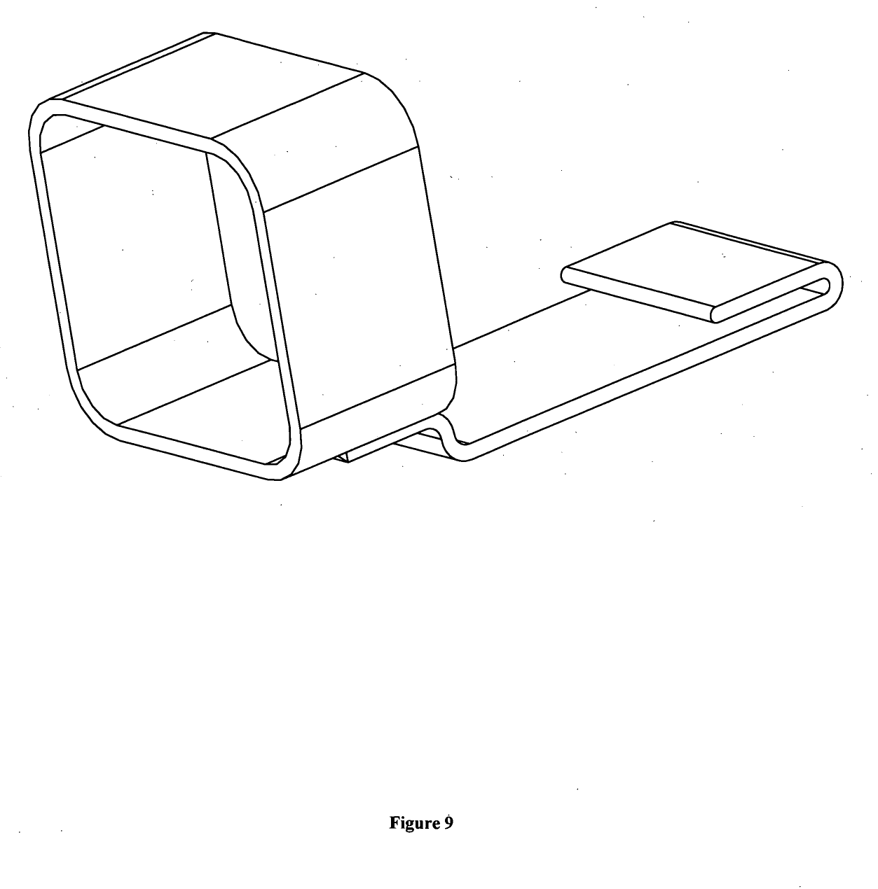

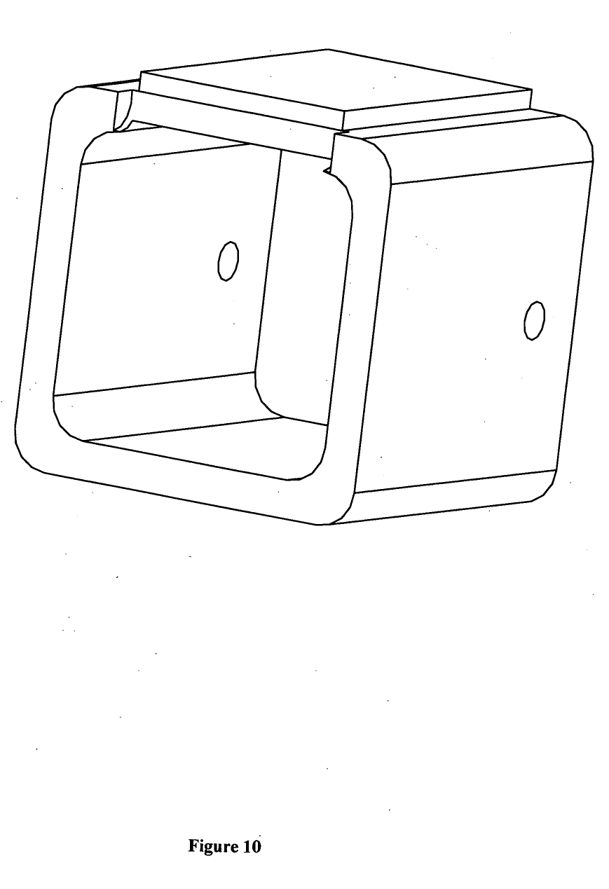

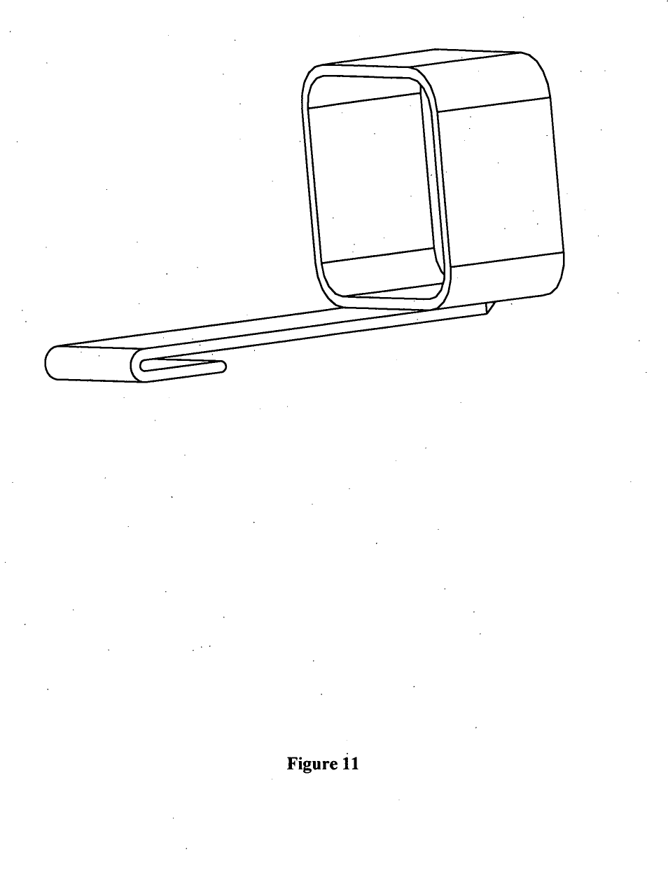

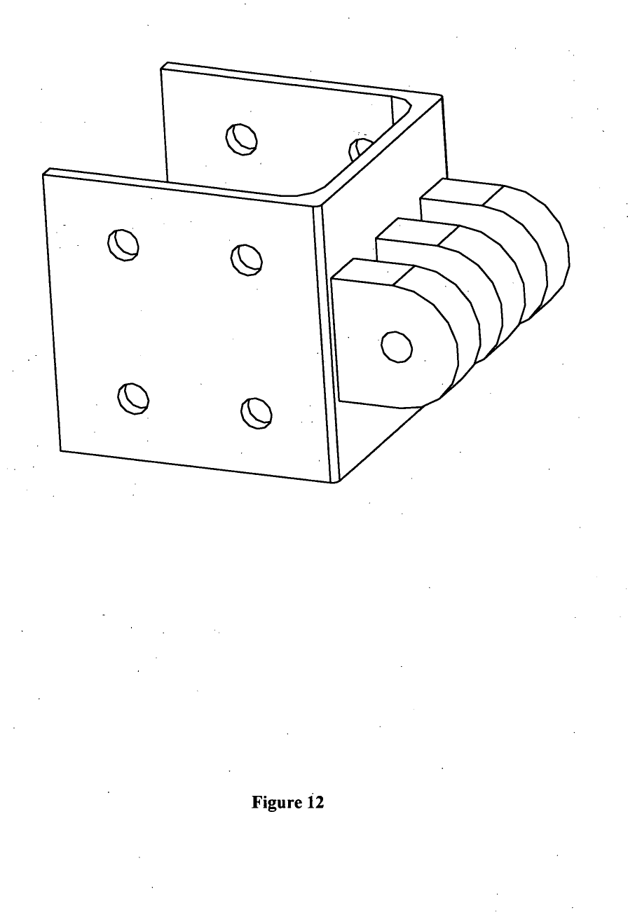

The leg supports are connected to the ends of a support beam assembly by means of a hinge mechanism. In a preferred embodiment, the legs are connected to the support assembly via a lock side as shown in FIG. 12. The upper support consists of two support beam assemblies connected via a hinge to allow the support beam to fold in the center. A sheath mechanism shown in FIGS. 9-11 is used to lock the support in an extended state.

Two support arms a connected to a support assembly and to a leg assembly to provide additional stability. One or both ends is held in place by a removable pin or bolt in order to allow for rapid disassembly.

Support pins and bolts used are preferentially half inch grade 8 or better steel for locking the leg assemblies.

A further description of a specific embodiment of the invention is provided as follows:

The complete hoisting frame collapses in the middle, the uprights fold inward and are manually retracted as well. The legs are stowed in the upright position and are locked in place.

The support assembly is the crossmember. This consists of two sections of rectangular steel tube 2″×4″×4′ 2″× 3/16″, reinforced internally ¼″ strap steel, the full length of each section (A1A)

These sections are joined in the middle of the C-member by a device, called a sheath, by means of collars that contain bolts that fix sections to saddle with clevis pins to lock the sections in place, thereby making one rigid C-member.

The sheath joins the C-member sections. It consists of two 2′×4″×¼″ plates joined by means of welds to a 3″×4″×¼″ C. channel, within the C-channel, the hoist hook is attached through a hole by a lock nut. The hook rides on a replaceable wear pad.

The leg assemblies are the uprights which support the C-member. These consist of two sections per side that slide within each other, that when upright allow the hoist to be raised to several heights. Within the lower tube, is a coil spring designed to assist the operator(s) in raising the upper tube. The reason for this is so one person can raise device by themselves if necessary.

The sections are secured to each other with clevis pins.

There are two legs per hoist end that fold down and are pinned with clevis pins to secure them in their down support position. They're also opposite each other. Wheels are attached; one per leg, so hoist can be rolled.

When hoist is in stowed position, the legs are secured in the upright position.

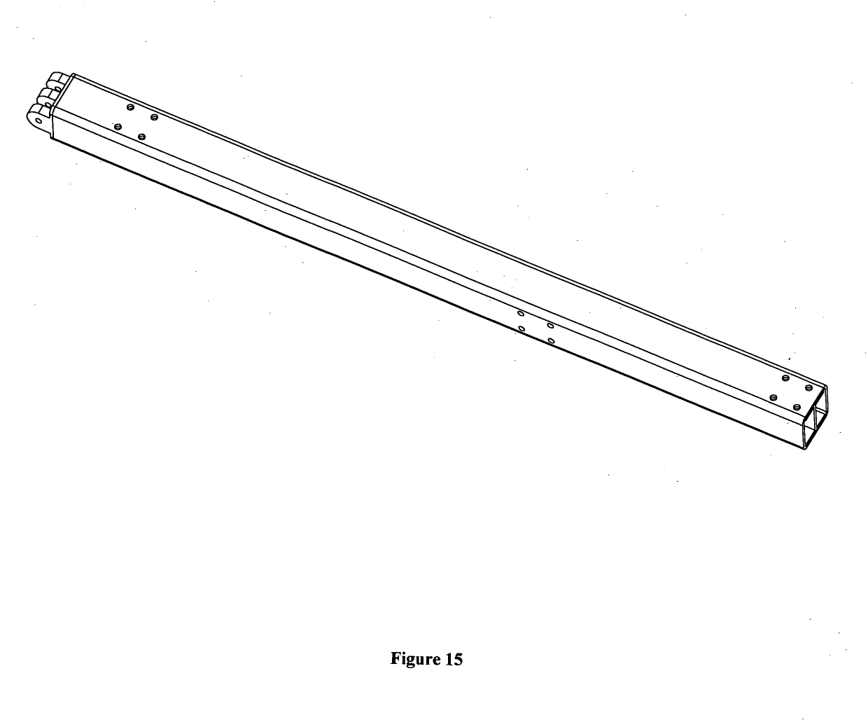

An angle support as shown in FIG. 15 is bolted or welded to the bottom of the leg assembly. The leg bases are then pinned or bolted into place either in a collapsed position or in an extended position.

In an alternative embodiment, the leg assembly is locked into place using pivoting braces able to be pinned in place when uprights and legs are in operating position.

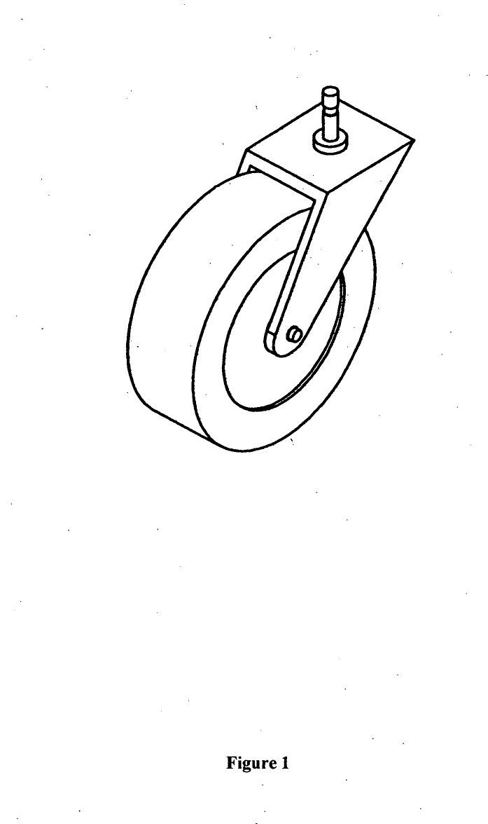

The castors shown in FIG. 1 are wheels that swivel and are removable. There are two sets, one for each leg, one set for hard, relatively even surfaces such as concrete, chat, etc. The other set would be inflatable, used for very uneven surfaces, such as would be found in a field, construction site, etc.

These next 2 components are not shown in drawing, but may be added, depending on the feasibility, and practicality.

First component would be a spring, or springs placed in or on the support assembly to assist in ease of unfolding C-member. These, as envisioned, would operate similarly to a diaper safety pin.

Second component would be a cable and pulley system incorporated into the design to assist in unfolding the hoist, and in addition assists in the raising and lowering of the C-member through the facilitation of the uprights. A hand operated winch using ¼″ steel cable would be used to implement operation.

Although the invention has been described in detail for the purpose of illustration, it is understood that such detail is solely for that purpose, and variations can be made therein by those skilled in the art without departing from the spirit and scope of the invention which is defined by the following claims.

What is claimed:

1. A hoist system comprising:
a frame comprising
a top horizontal member having a saddle and a hinge, where the hinge can be folded for storage or locked into position,
and two leg members each having an extendable central support and two folding support structures,
hinged junction between the horizontal member and the central support members; and
a saddle for attaching a lifting mechanism.

2. The hoist according to claim 1, wherein the hinge is locked into position by a bolt, a pin or a sleeve.

3. The hoist according to claim 1, wherein the height of the top horizontal member is at least eight feet above a surface the hoist on which the hoist is set up.

4. The hoist according to claim 1, wherein the height of the top horizontal member is at least ten feet above a surface the hoist on which the hoist is set up.

5. The hoist according to claim 1, wherein the hoist is constructed out of aluminum.

6. The hoist according to claim 1, wherein the total weight of the hoist is less than 500 pounds.

7. The hoist according to claim 1, wherein the total weight of the hoist is less than 300 pounds.

8. The hoist according to claim 1, wherein one or more of the extending support structures has wheels.

9. The hoist according to claim 1, wherein the hoist can support a minimum of 5000 pounds.

10. The hoist according to claim 1, wherein the hoist can support a minimum of 8000 pounds.
